(19) United States
(12) Patent Application Publication
(10) Pub. No.: US 2018/0224851 A1
(43) Pub. Date: Aug. 9, 2018

(54) METHOD AND APPARATUS FOR CONTROLLING AUTONOMOUS DRIVING VEHICLE USING DEAD RECKONING

(71) Applicant: Electronics and Telecommunications Research Institute, Daejeon (KR)

(72) Inventor: MYUNGWOOK PARK, Daejeon (KR)

(73) Assignee: Electronics and Telecommunications Research Institute, Daejeon (KR)

(21) Appl. No.: 15/883,511

(22) Filed: Jan. 30, 2018

(30) Foreign Application Priority Data
Feb. 6, 2017 (KR) 10-2017-0016393

(51) Int. Cl. G05D 1/00

(52) U.S. Cl. CPC G05D 1/0088; B60W 2710/18

(57) ABSTRACT

Disclosed are a method and apparatus for effectively controlling an autonomous driving vehicle in an abnormal condition in which a navigation system and/or an autonomous driving system malfunctions. The apparatus for controlling the autonomous driving vehicle includes a position recognition unit for generating first position information by recognizing a position of the autonomous driving vehicle, a state determination unit for determining whether the position recognition unit is in an abnormal state, a dead reckoning unit for generating second position information by predicting a position of the autonomous driving vehicle using dead reckoning, a data providing unit for selecting either the first position information or the second position information depending on a determination result of the state determination unit, and a vehicle controller for controlling the autonomous driving vehicle based on a section result of the data providing unit.

### CROSS REFERENCE TO RELATED APPLICATION

The present application claims priority to Korean Patent Application No. 10-2017-0016393, filed Feb. 6, 2017, the entire contents of which is incorporated herein for all purposes by this reference.

### BACKGROUND OF THE INVENTION

### Field of the Invention

The present disclosure relates generally to control of an autonomous driving vehicle. More particularly, the present disclosure relates to a method and apparatus for controlling an autonomous driving vehicle by using dead reckoning.

### Description of the Related Art

Generally, for safe and stable driving of an autonomous driving vehicle, position information of the vehicle has to be accurately known. Conventional autonomous driving vehicles use an inertial navigation system (INS) that combines a signal of a global positioning system (GPS) and a compensation signal of a virtual reference system (VRS), and integrates the combined signal and inertial measurement unit (IMU) information, as a navigation system for recognizing the current position of a vehicle.

However, such a navigation system requires expensive equipment. For this reason, recently there has been an approach to recognize an absolute position of an autonomous driving vehicle by integrating a relatively inexpensive GPS, a vision sensor, and a wheel encoder.

As stated above, the research into lowering the cost of sensors and reducing position errors is ongoing to solve the problems of conventional navigation systems. In addition, the control of conventional autonomous driving vehicles has a problem that when a navigation system malfunctions, an autonomous driving system cannot properly cope with the malfunctioning of the navigation system. Furthermore, the same problem also occurs when a certain functional unit (for example, a planning and/or determining function) of an autonomous driving system does not normally work although a navigation system normally functions.

Therefore, measures for properly and effectively dealing with malfunctioning of a navigation system and/or an autonomous driving system are required.

### SUMMARY OF THE INVENTION

An objective of the present disclosure is to provide a method and apparatus for effectively controlling an autonomous driving vehicle.

Another objective of the present disclosure is to provide a method and apparatus for effectively controlling (for example, emergency braking) a vehicle in an emergency situation in which either or both of a navigation system and an autonomous driving system malfunction.

The objectives of the present disclosure are not limited to the above stated ones, and other objectives of the present disclosure will be more clearly understood from the following detailed description.

In order to accomplish the above objectives, according to one aspect of the present disclosure, there is provided an apparatus for controlling an autonomous driving vehicle, the apparatus including: a position recognition unit configured to generate first position information by recognizing a position of an autonomous driving vehicle; a state determination unit configured to determine whether the position recognition unit is in an abnormal state; a dead reckoning unit configured to generate second position information by predicting a position of the autonomous driving vehicle using dead reckoning; a data providing unit configured to select either the first position information or the second position information, depending on a determination result of the state determination unit; and a vehicle controller configured to control the autonomous driving vehicle based on a selection result of the data providing unit.

In the apparatus, the position recognition unit may include at least one of a global positioning system (GPS), a virtual reference system (VRS), an inertial measurement unit (IMU), and an inertial navigation system (INS).

The apparatus may further include a decision making/planning unit configured to generate motion control information of the autonomous driving vehicle, based on at least one of the first position information, digital map information, and driving environment recognition information, in which the state determination unit determines whether the decision making/planning unit is in an abnormal state.

In the apparatus, the state determination unit may determine whether the position recognition unit is in an abnormal state, based on time information included in the first position information and determine whether the decision making/planning unit is in an abnormal state, based on index information included in the motion control information.

The apparatus may further include a vehicle sensor unit configured to detect at least one of a yaw rate, a wheel speed, a longitudinal speed, and a longitudinal acceleration of the autonomous driving vehicle, in which the dead reckoning unit generates the second position information, based on sensing information detected by the vehicle sensor unit.

In the apparatus, the data providing unit may select the second position information when the state determination unit determines the position recognition as being abnormal, and select the first position information when the state determination unit determines the position recognition unit as being normal.

In the apparatus, the dead reckoning unit may derive current position information based on the first position information, predict information of at least one of a vehicle heading, a vehicle speed, and a road slope, based on the sensing information detected by the vehicle sensor unit, and generate the second position information by applying at least one piece of the predicted information to the current position information.

In the apparatus, the dead reckoning unit may initialize the second position information based on the first position information when a duration time in which the second position information is continuously generated is longer than a predetermined time or an error of the second position information is greater than a predetermined allowable error.

In the apparatus, the dead reckoning unit may update the second position information by using the second position information as the current position information when a duration time in which the second position information is continuously generated is not longer than a predetermined time or an error of the second position information is not greater than a predetermined allowable error.

In the apparatus, the vehicle controller may perform emergency braking of the autonomous driving vehicle when the state determination unit determines the position recognition unit as being abnormal.

According to another aspect of the present disclosure, there is provided a method for controlling an autonomous driving vehicle, the method including: generating first position information by recognizing a position of an autonomous driving vehicle; determining whether the first position information is generated in an abnormal state; generating second position information by predicting a position of the autonomous driving vehicle using dead reckoning; selecting either the first position information or the second position information based on a result of the determining of whether the first position information is generated in an abnormal state; and controlling the autonomous driving vehicle based on a selection result of the selecting of the first position information or the second position information.

In the method, the generating of the first position information may be performed by using at least one of a global positioning system (GPS), a virtual reference system (VRS), an inertial measurement unit (IMU), and an inertial navigation system (INS).

The method may further include generating motion control information of the autonomous driving vehicle, based on at least one of the first position information, digital map information, and driving environment recognition information, in which the determining comprises determining whether the motion control information is generated in an abnormal state.

In the method, the determining may include determining whether the first position information is generated in an abnormal state based on time information included in the first position information; and determining whether the motion control information is generated in an abnormal state based on index information included in the motion control information.

The method may further include sensing at least one of a yaw rate, a wheel speed, a longitudinal speed, and a longitudinal acceleration of the autonomous driving vehicle, in which the generating of the second position information includes generating the second position information based on sensing information sensed in the sensing.

In the method, the selecting of either the first position information or the second position information may include: selecting the second position information when it is determined that the first position information is generated in an abnormal state in the determining; and selecting the first position information when it is determined that the first position information is generated in a normal state in the determining.

In the method, the generating of the second position information may include: deriving current position information based on the first position information; predicting information of at least one of a vehicle heading, a vehicle speed, and a road slope based on the sensing information sensed in the sensing; and generating the second position information by applying at least a piece of the predicted information to the current position information.

In the method, the generating of the second position information may further include initializing the second position information based on the first position information when a duration time in which the second position information is continuously generated is longer than a predetermined time or when an error of the second position information is greater than a predetermined allowable error.

In the method, the generating of the second position information further include updating the second position information by using the second position information as the current position information when a duration time in which the second position information is continuously generated is not longer than a predetermined time or when an error of the second position information is not greater than a predetermined allowable error.

In the method, the controlling of the autonomous driving vehicle may include emergency braking of the autonomous driving vehicle when it is determined that the first position information is generated in an abnormal state in the determining.

According to a further aspect of the present disclosure, there is provided software or a computer-readable medium including executable instructions for implementing the method for controlling an autonomous driving vehicle.

The above briefly summarized features and advantages of the present disclosure are only for illustrative purposes and should not be construed as limiting the scope of the present disclosure.

As described above, the present disclosure provides a method and apparatus for effectively controlling an autonomous driving vehicle.

The present disclosure provides a method and apparatus for effectively controlling (for example, emergency braking) an autonomous driving vehicle in an emergency situation, for example, in an event in which a determining/planning/deciding function of either or both of a navigation system and an autonomous driving system malfunctions.

The advantages and features of the present disclosure are not limited to ones stated above, and other advantages and features of the present disclosure will be more clearly understood from the following detailed description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view illustrating construction and operation of an autonomous driving system according to one embodiment of the present disclosure;

FIGS. 2A and 2B are diagrams illustrating one embodiment of operation of a state determination unit 111 of a motion control unit 110 of FIG. 1;

FIG. 3 is a diagram illustrating one embodiment of a dead reckoning unit 112 of the motion control unit 110 of FIG. 1;

FIG. 4 is a diagram illustrating one embodiment of operation of a position prediction unit 305 of the dead reckoning unit 112 of FIG. 3; and

FIG. 5 is a diagram illustrating one embodiment of operation of a data providing unit 113 of the motion control unit 110 of FIG. 1.

### DETAILED DESCRIPTION OF THE INVENTION

Hereinbelow, exemplary embodiments of the present disclosure will be described in detail such that the ordinarily skilled in the art would easily understand and implement an apparatus and a method provided by the present disclosure in conjunction with the accompanying drawings. However, the present disclosure may be embodied in various forms and the scope of the present disclosure should not be construed as being limited to the exemplary embodiments.

In describing embodiments of the present disclosure, well-known functions or constructions will not be described in detail when they may obscure the spirit of the present disclosure. Further, parts not related to description of the present disclosure are not shown in the drawings and like reference numerals are given to like components.

In the present disclosure, it will be understood that when an element is referred to as being “connected to”, “coupled to”, or “combined with” another element, it can be directly connected or coupled to or combined with the another element or intervening elements may be present therebetween. It will be further understood that the terms “comprises”, “includes”, “have”, etc. when used in the present disclosure specify the presence of stated features, integers, steps, operations, elements, components, and/or combinations thereof but do not preclude the presence or addition of one or more other features, integers, steps, operations, elements, components, and/or combinations thereof.

It will be understood that, although the terms “first”, “second”, etc. may be used herein to describe various elements, these elements should not be limited by these terms. These terms are only used to distinguish one element from another element and not used to show order or priority among elements. For instance, a first element discussed below could be termed a second element without departing from the teachings of the present disclosure. Similarly, the second element could also be termed as the first element.

In the present disclosure, distinguished elements are termed to clearly describe features of various elements and do not mean that the elements are physically separated from each other. That is, a plurality of distinguished elements may be combined into a single hardware unit or a single software unit, and conversely one element may be implemented by a plurality of hardware units or software units. Accordingly, although not specifically stated, an integrated form of various elements or separated forms of one element may fall within the scope of the present disclosure.

In the present disclosure, all of the constituent elements described in various embodiments should not be construed as being essential elements but some of the constituent elements may be optional elements. Accordingly, embodiments configured by respective subsets of constituent elements in a certain embodiment also may fall within the scope of the present disclosure. In addition, embodiments configured by adding one or more elements to various elements also may fall within the scope of the present disclosure.

Herein below, exemplary embodiments of the present disclosure will be described with reference to the accompanying drawings.

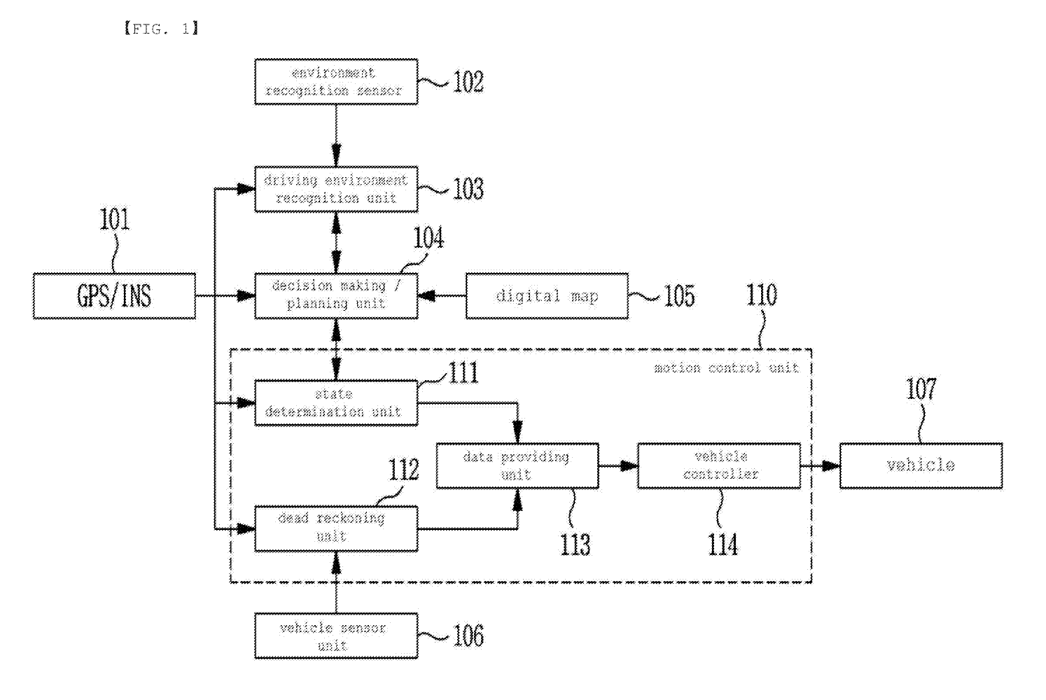

FIG. 1 is a schematic view illustrating construction and operation of an autonomous driving system according to one embodiment of the present disclosure.

Referring to FIG. 1, the autonomous driving system may include a driving environment recognition unit 103, a decision making/planning unit 104, and a motion control unit 110.

The driving environment recognition unit 103 may recognize a traveling space and road infrastructure in various driving environments, based on data detected by various environment recognition sensors 102, and provides the recognized information (hereinafter, referred to as driving environment recognition information) to the decision making/planning unit 104. The driving environment recognition information may include at least one kind of the information: a traversable region; a position, speed, and type of an object; and a shape, position, and state of a lane, stop line, crosswalk, and traffic light.

The decision making/planning unit 104 may determine driving environments based on position information provided by a position recognition system such as a GPS/INS 101, the driving environment recognition information provided by the driving environment recognition unit 103, and/or digital map information 105. The decision making/planning unit 104 may generate motion control information of the autonomous driving vehicle based on driving conditions, and provides the motion control information to the motion control unit 110. The motion control information of the autonomous driving vehicle may include information of a driving path and/or a target speed.

In the present disclosure, the position recognition system may mean a system for determining a position of the autonomous driving vehicle and may include various kinds of position recognition systems including the GPS/INS 101. Accordingly, in the present disclosure, the position recognition system may not be limited to the GPS/INS 101 but be substituted by a different type of position recognition system.

The motion control unit 110 may control (for example, driving in a lateral direction and/or a longitudinal direction of) an autonomous driving vehicle 107, based on the information such as a driving path and/or a target speed provided by the decision making/planning unit 104. Alternatively, the motion control unit 110 may determine an emergency situation based on the information provided by the decision making/planning unit 104 and/or data detected by a vehicle sensor unit, and appropriately control the autonomous driving vehicle 107 to respond to the abnormal situation. For example, the motion control unit 110 may turn on an emergency lamp or cause emergency braking of the autonomous driving vehicle.

The motion control unit 110 may include a state determination unit 111, a dead reckoning unit 112, a data providing unit 113, and/or a vehicle controller 114.

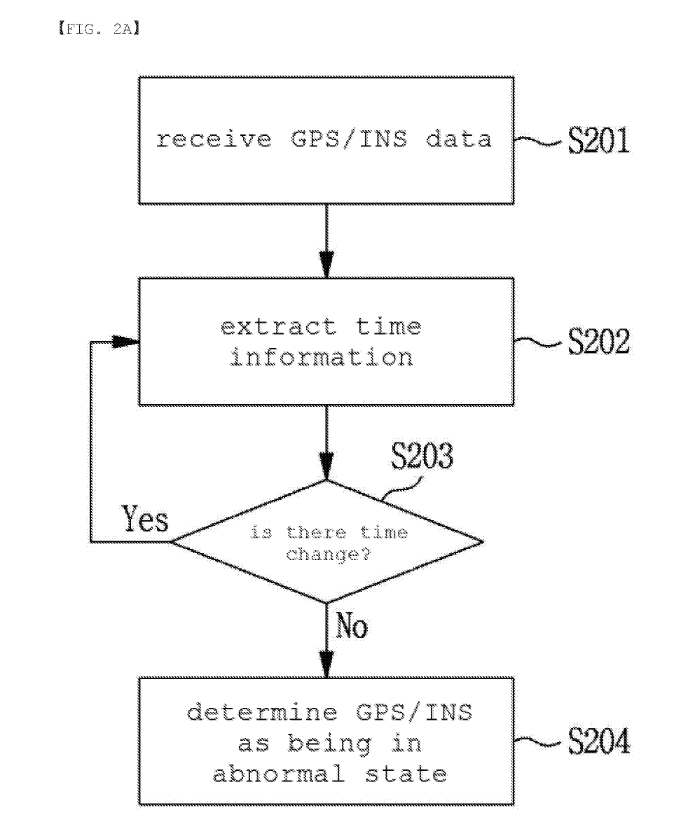

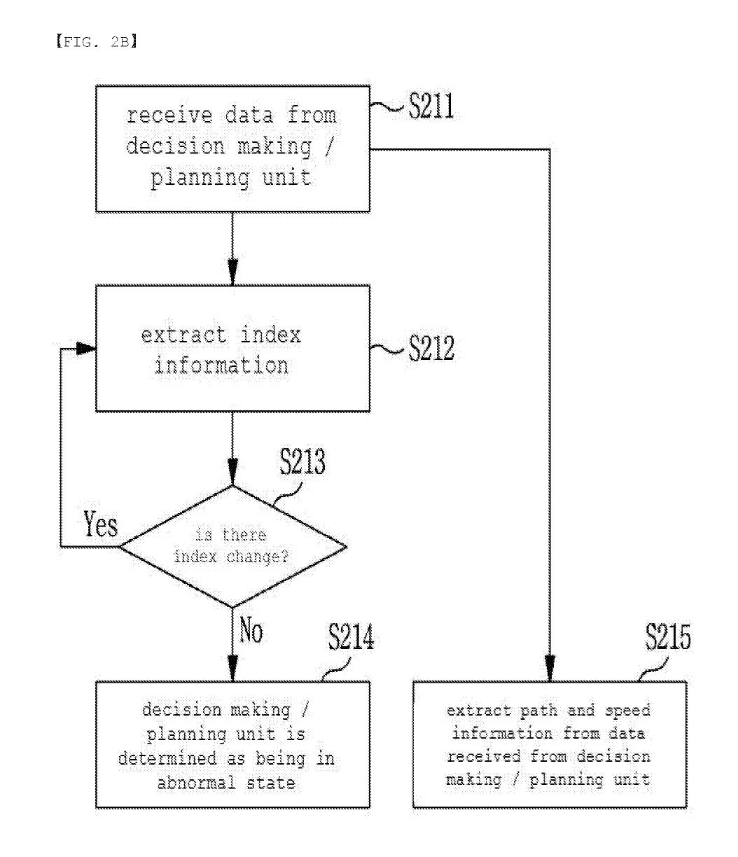

FIG. 2 is a diagram illustrating embodiment of operation of the state determination unit of the motion control unit 110 of FIG. 1.

The state determination unit 111 may determine a state of each constituent unit of the autonomous driving vehicle and the autonomous driving system based on the information provided by the GPS/INS 101 and/or the decision making/planning unit 104.

As illustrated in FIG. 2A, the state determination unit 111 may receive GPS/INS data at Step S201. The state determination unit 111 may extract time information from the GPS/INS data at Step S202, and monitor the extracted time information or the updates of the time information, thereby determining a change in time at Step S203.

When it is determined that there is no time change (“NO” at Step S203), the state determination unit 111 may determine the GPS/INS 101 as being in an abnormal state at Step S204. Examples of the abnormal state of the GPS/INS 101 may include malfunctioning of the GPS/INS 101, communication disconnection, or the like.

When it is determined that there is a time change (“YES” at Step S203), the state determination unit 111 may determine the GPS/INS 101 as being in a normal state, and repeats the previous processes with respect to newly received GPS/INS data. Although, in the example of FIG. 2A, the process returns to Step S202 after the determination of Step S203, the present disclosure may not be limited thereto. That is, the process may return to Step S201 after the determination of Step S203.

In addition, as illustrated in FIG. 2B, the state determination unit 111 may receive data from the decision making/planning unit 104 at Step S211. The state determination unit 111 may extract index information (for example, path index information) from the data provided by the decision making/planning unit 104 (Step S212). The index information includes all kinds of information by which data provided a plurality of times by the decision making/planning unit 104 can be distinguished, and may not be limited to information having the form of an index. The state determination unit 111 may monitor extracted index information and determine whether there is a change in the index information (for example, an increase in the index) at Step S213.

When it is determined there is no index change (“NO” at Step S213), the state determination unit 111 may determine that the decision making/planning unit 104 is in an abnormal state at Step S214. Examples of the abnormal state of the decision making/planning unit 104 may include malfunctioning or operation stopping of the decision making/planning unit 104, communication disconnection, etc.

When it is determined that there is an index change (“YES” at Step S213), the state determination unit may determine that the decision making/planning unit 104 is in a normal state and continuously performs the above process with respect to the data provided by the decision making/planning unit 104. Although FIG. 2B illustrates that the process returns to Step S212 after the determination of Step S213, the present disclosure is not limited thereto. For example, after the determination of Step S213, the process may return to Step S211.

The determination of whether the decision making/planning unit 104 is in a normal state or an abnormal state may not be necessarily performed only based on the index information, but may be performed based on a predetermined state message provided by the decision making/planning unit 104.

The determination results of the state determination unit 111 based on the GPS/INS data and/or the data provided by the decision making/planning unit 104 may be provided to the data providing unit 113. In addition, the information provided by the decision making/planning unit 104 also may be provided to the data providing unit 113. Thus, the state determination unit 111 may extract information of a driving path and/or a target speed from the data provided by the decision making/planning unit 104 at Step S215.

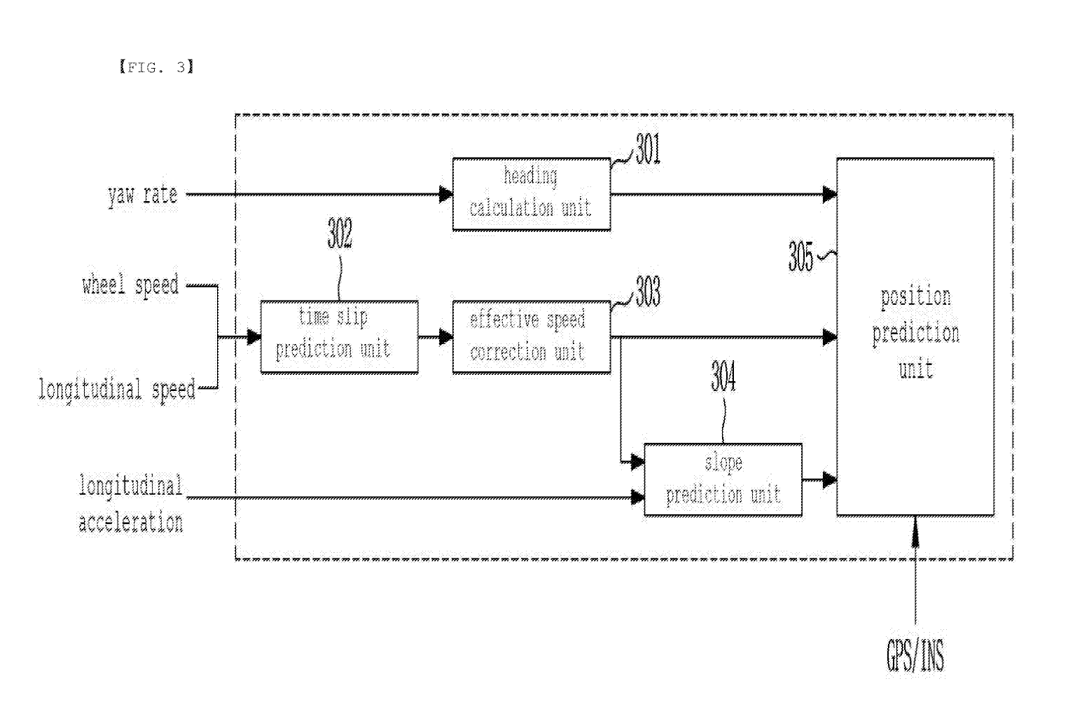

FIG. 3 is a diagram illustrating an embodiment of the dead reckoning unit 112 of the motion control unit 110 of FIG. 1.

The dead reckoning unit 112 may include a heading calculation unit 301, a tire slip prediction unit 302, an effective speed correction unit 303, a slope prediction unit 304, and/or a position prediction unit 305.

The dead reckoning unit 112 may use a sensing result of a vehicle sensor 106 in order to respond to the abnormal state of the GPS/INS 101 and/or the decision making/planning unit 104. The vehicle sensor unit 106 may include at least one sensor installed inside the autonomous driving vehicle. The information provided by the vehicle sensor unit 106 may include a yaw rate, a wheel speed, a longitudinal speed, and a longitudinal acceleration of the vehicle.

In order to predict a position of the autonomous driving vehicle using dead reckoning, information of a vehicle heading, a vehicle speed, and/or a road slope may be used. The heading calculation unit 301 may predict the heading of the vehicle based on the yaw rate per a unit time. The tire slip prediction unit 302 may predict a tire slip based on the wheel speed and the longitudinal speed of the vehicle. The effective speed correction unit 303 may calculate an accurate vehicle speed by correcting an effective speed of the vehicle, based on the predicted tire slip. The slope prediction unit 304 may predict a slope angle of a road based on the value of the longitudinal acceleration on which the effective vehicle speed and the gravity are reflected. For example, the slope prediction unit 304 may compare the effective vehicle speed and the value of the longitudinal acceleration on which the gravity is reflected.

The position prediction unit 305 may predict and/or determine a current position of the vehicle using the GPS/INS data and/or information of a vehicle heading, an effective vehicle speed and a road slope which are predicted based on information provided by the vehicle sensor unit 106.

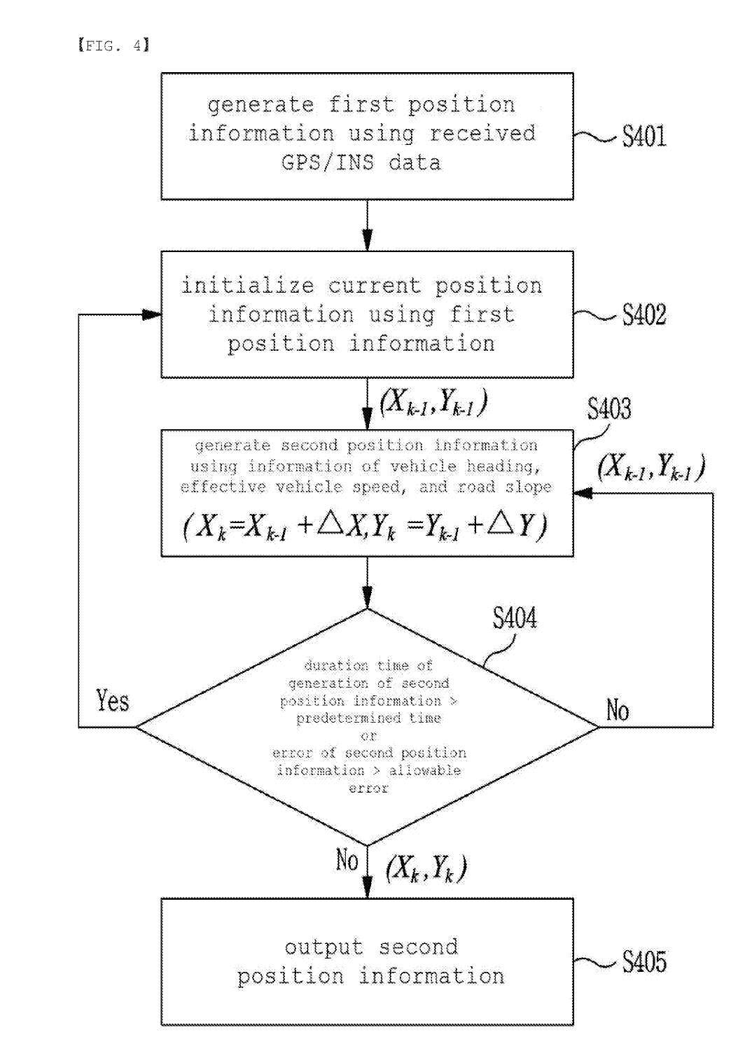

FIG. 4 is a diagram illustrating an embodiment of operation of the position prediction unit 305 of the dead reckoning unit 112 of FIG. 3.

The position prediction unit 305 may receive the GPS/INS data and generate first position information using the GPS/INS data at Step S401. At Step S402, for dead reckoning, current position information may be initialized based on the first position information. At Step S403, second position information (Xk, Yk) may be generated based on the initialized current position information and based on information of a vehicle heading, an effective vehicle speed, and a road slope angle. At Step S403, the ΔX and/or ΔY may be derived based on the information of a vehicle heading, an effective vehicle speed, and/or a road slope angle.

The second position information generated using the dead reckoning may have an error that cumulatively increases as time passes or as the number of calculations increases. Accordingly, at Step S404, whether a duration time during which the second position information is continuously generated is equal to or longer than a predetermined time or whether an error of the second position information is equal to or greater than a predetermined allowable error may be determined. For example, when the duration time during which the second position information is continuously generated is longer than the predetermined time or when the second position information is generated before the starting of the predetermined time, the error of the generated second position information is determined as exceeding the predetermined allowable error.

In the case of “YES” at Step S404, the error of the second position information is determined as exceeding the predetermined allowable error, and the process returns to Step S402 such that the current position information is initialized based on the GPS/INS data. Alternatively, the process may return to Step S401 such that the first position information is generated based on newly received GPS/INS data.

In the case of “NO” at Step S404, the error of the second position information is determined as being within an allowable error range, and the process proceeds to Step S403 such that the second position information is updated. In order to update the second position information, current second position information may be input in the form of a coordinate (Xk−1, Yk−1) at Step S403. In addition, the second position information having an error less than the allowable error may be determined as being effective and thus be output at Step S405.

The first position information (i.e., the position information provided by the GPS/INS 101) and the second position information (i.e. final predicted position information of the vehicle) generated by the position prediction unit 305 may be provided to the data providing unit 113.

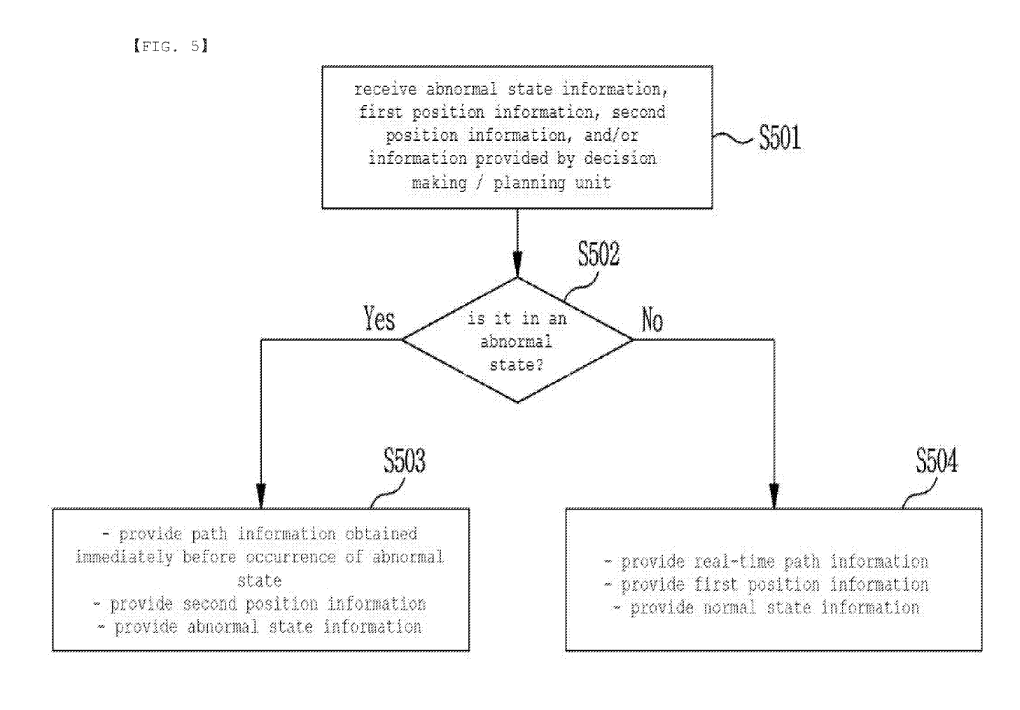

FIG. 5 is a diagram illustrating one embodiment of operation of the data providing unit 113 of the motion control unit 110 of FIG. 1.

The data providing unit 113 may provide a driving path, a vehicle speed, position information, etc. to the vehicle controller 114, depending on the determination result of whether the GPS/INS 101 and/or the decision making/planning unit 104 are in the normal state or in the abnormal state.

The data providing unit 113 may receive the information associated with the abnormal state, which is provided by the state determination unit 111, the first position information and/or the second position information provided by the dead reckoning unit 112, and/or the driving path and/or the vehicle speed provided by the decision making/planning unit 104 at Step S501.

At Step S502, a determination of whether either or both of the position recognition system and the autonomous driving system are abnormal may be made. The determination at Step S502 may be performed based on information (abnormal state information) associated with the abnormal state, which is received at Step S501.

In an abnormal situation (“YES” at Step S502), the driving path, speed, position information that are obtained before occurrence of the abnormal state and/or the abnormal state information may be provided to the vehicle controller 114 at Step S503. In the abnormal situation, the position information used to determine a current position of the vehicle may be the second position information. In addition, a control command associated with the speed may be “STOP”.

In a normal situation (“NO” at Step S502), the driving path, speed, and position information that are obtained in real time and the information (normal state information) associated with the normal state provided by the decision making/planning unit 104 may be provided to the vehicle controller 114 at Step S504. In the normal situation, the position information used to determine the current position of the vehicle may be the first position information.

The vehicle controller 114 may control driving of the autonomous driving vehicle 107 by performing path following and/or speed following based on the driving path, speed, position, and/or state information (situation information) provided by the data providing unit 111. Therefore, in the normal situation, the vehicle control may be performed based on the information provided by the decision making/planning unit 104. Conversely, in the abnormal situation, the vehicle control may be performed based on information provided by the dead reckoning unit 112. That is, during the abnormal situation, the vehicle control may be performed based on information obtained immediately before the occurrence of the abnormal situation. In addition, in the abnormal situation, an emergency lamp may be turned on, or emergency braking may be performed.

Emergency braking may be performed in various conditions in an emergency situation. The various conditions may be determined based on information associated with a driving environment, for example, digital map and information collected by the GPS/INS, the vehicle sensor, etc.

Emergency braking may be performed based on the vehicle speed in an emergency situation. For example, the following distance at the time of performing emergency braking in an emergency situation may be determined based on the vehicle speed. By determining the following distance in accordance with the vehicle speed, it is possible to reduce a shock to occupants in the vehicle.

Emergency braking may be performed based on the road slope in an emergency situation. When driving on an uphill road, the following distance of the vehicle may be inversely proportional to the inclination angle of the road. However, when driving on a downhill road, the following distance of the vehicle may be proportional to the inclination angle of the road.

Emergency braking may be performed based on the driving path in an emergency situation. A stop position of the vehicle at the time of emergency braking may be determined to avoid specific positions on the driving path. One of the specific positions may be a high risk position where a traffic accident is highly likely to occur when a vehicle stops there. For example, the specific position may be a position within a predetermined distance from a corner of a street, a position in the middle of a road in a heavy traffic area, a position in the middle of an intersection or at a road junction, or a position at which roads merge or branch off. The specific positions may be identified on the driving path and/or digital map.

The stop position of the vehicle at the time of emergency braking may be the outermost lane or the shoulder of a road. The autonomous driving system according to the present disclosure may collect information of lanes adjacent to the current driving lane of the vehicle, the shoulders, and/or moving or stationary objects. Examples of the object may include driving vehicles or parked vehicles, people, and things. That is, the environment recognition sensors 102, the driving environment recognition unit 103, the vehicle sensor 106, and/or the decision making/planning unit 104 may collect the information of the objects and the road. The dead reckoning unit 112 may predict the information based on dead reckoning. For example, the dead reckoning unit 112 may predict the position information of an object. The collected information and/or the predicted information may be provided to the motion control unit 110. The motion control unit 110 may receive information of a total number of lanes of the road, the current driving lane of the vehicle on the road, presence or absence of the shoulder of the road, the width of the road, etc. Emergency braking may be performed based on a determination of whether there is an object on the target lane where the vehicle is to be stopped. When there is no object (for example, no driving car) on the target lane, the vehicle is controlled to move to the target lane and then emergency braking of the vehicle is performed. When there is a driving car on the target lane but the car is in a far distance from the autonomous driving vehicle, the autonomous driving vehicle is controlled to move to the target lane and then the emergency braking of the vehicle is performed there. When there is a stopped car on the target lane, the autonomous driving vehicle is controlled to move to the target lane after passing the stopped car and is then braked to stop at a position ahead of the stopped car. The changing of the driving lane to the target lane may be performed based on the information (lane information and/or road width information) transmitted to the motion control unit 110 immediately before the occurrence of the emergency situation. When the road has a shoulder, the vehicle may be stopped at the shoulder. However, when the road has no shoulder, the target lane for emergency braking may be the outermost lane. In this case, the emergency braking may be performed such that the vehicle stops preferably at a position as close as possible to the outer edge of the road (i.e. a position outside the outermost lane of the road).

The autonomous driving system according to the present disclosure may be equipped with an additional position recognition unit (not illustrated). The additional position recognition unit may recognize the position of a vehicle by receiving information from the environment recognition sensors 102, the GPS/INS 101, and/or the vehicle sensor 106. The additional position recognition unit may recognize the position of the vehicle with only the information provided by the environment recognition sensors 102 and the vehicle sensor 106 without using the information received from the GPS/INS 101. In this case, it is possible to recognize the absolute position of the vehicle by using the digital map as well as the information provided by the environment recognition sensors 102 and the vehicle sensor 106. Therefore, even in a situation in which the position recognition sensor (i.e. GPS/INS) malfunctions, the position of the vehicle can be recognized and thus the autonomous driving of the vehicle is possible.

In the case of the autonomous driving system equipped with the additional position recognition unit, when the position recognition unit malfunctions, the motion control unit 110 may receive the information of the recognized driving environment. That is, the decision making/planning unit 104 that normally functions may provide the information of the recognized driving environment to the motion control unit 110. In addition, the decision making/planning unit 104 may receive position information of the vehicle predicted through the dead reckoning. In the case where the decision making/planning unit 104 normally works but the position recognition unit malfunctions, the vehicle is controlled to change the driving lane, then to move into the shoulder, and then to stop on the shoulder. When there is no shoulder, the vehicle is controlled to move to the outermost lane and is then stopped there. According to the present disclosure, since it is possible to recognize the lanes of a road and/or objects and to receive the predicted position information of the vehicle based on dead reckoning, it is possible to effectively make a decision and/or planning for autonomous driving and emergency braking.

Although exemplary methods of the present disclosure are described as a series of operation steps for clarity of a description, the present disclosure is not limited to the sequence or order of the operation steps described above. The operation steps may be simultaneously performed, or may be performed sequentially but in different order. In order to implement the method of the present disclosure, additional operation steps may be added and/or existing operation steps may be eliminated or substituted.

Various embodiments of the present disclosure are not presented to describe all of available combinations but are presented to describe only representative combinations. Steps or elements in various embodiments may be separately used or may be used in combination.

In addition, various embodiments of the present disclosure may be embodied in the form of hardware, firmware, software, or a combination thereof. When the present disclosure is embodied in a hardware component, it may be, for example, an application specific integrated circuit (ASIC), a digital signal processor (DSP), a digital signal processing device (DSPD), a programmable logic device (PLD), a field programmable gate array (FPGA), a general processor, a controller, a microcontroller, a microprocessor, etc.

The scope of the present disclosure includes software or machine-executable instructions (for example, operating systems (OS), applications, firmware, programs) that enable methods of various embodiments to be executed in an apparatus or on a computer, and a non-transitory computer-readable medium storing such software or machine-executable instructions so that the software or instructions can be executed in an apparatus or on a computer.

1. An apparatus for controlling an autonomous driving vehicle, the apparatus comprising:
a position recognition unit configured to generate first position information by recognizing a position of an autonomous driving vehicle;
a state determination unit configured to determine whether the position recognition unit is in an abnormal state;
a dead reckoning unit configured to generate second position information by predicting a position of the autonomous driving vehicle using dead reckoning;
a data providing unit configured to select either the first position information or the second position information, depending on a determination result of the state determination unit; and
a vehicle controller configured to control the autonomous driving vehicle based on a selection result of the data providing unit.

2. The apparatus according to claim 1, wherein the position recognition unit comprises at least one of a global positioning system (GPS), a virtual reference system (VRS), an inertial measurement unit (IMU), and an inertial navigation system (INS).

3. The apparatus according to claim 1, further comprising a decision making/planning unit configured to generate motion control information of the autonomous driving vehicle, based on at least one of the first position information, digital map information, and driving environment recognition information,
wherein the state determination unit determines whether the decision making/planning unit is in an abnormal state.

4. The apparatus according to claim 3, wherein the state determination unit determines whether the position recognition unit is in an abnormal state, based on time information included in the first position information and determines whether the decision making/planning unit is in an abnormal state, based on index information included in the motion control information.

5. The apparatus according to claim 1, further comprising a vehicle sensor unit configured to detect at least one of a yaw rate, a wheel speed, a longitudinal speed, and a longitudinal acceleration of the autonomous driving vehicle,
wherein the dead reckoning unit generates the second position information, based on sensing information detected by the vehicle sensor unit.

6. The apparatus according to claim 1, wherein the data providing unit selects the second position information when the state determination unit determines the position recognition as being abnormal, and selects the first position information when the state determination unit determines the position recognition unit as being normal.

7. The apparatus according to claim 5, wherein the dead reckoning unit derives current position information based on the first position information, predicts information of at least one of a vehicle heading, a vehicle speed, and a road slope, based on the sensing information detected by the vehicle sensor unit, and generates the second position information by applying at least one piece of the predicted information to the current position information.

8. The apparatus according to claim 7, wherein the dead reckoning unit initializes the second position information based on the first position information when a duration time in which the second position information is continuously generated is longer than a predetermined time or an error of the second position information is greater than a predetermined allowable error.

9. The apparatus according to claim 7, wherein the dead reckoning unit updates the second position information by using the second position information as the current position information when a duration time in which the second position information is continuously generated is not longer than a predetermined time or an error of the second position information is not greater than a predetermined allowable error.

10. The apparatus according to claim 1, wherein the vehicle controller performs emergency braking of the autonomous driving vehicle when the state determination unit determines the position recognition unit as being abnormal.

11. A method for controlling an autonomous driving vehicle, the method comprising:
generating first position information by recognizing a position of an autonomous driving vehicle;
determining whether the first position information is generated in an abnormal state;
generating second position information by predicting a position of the autonomous driving vehicle using dead reckoning;
selecting either the first position information or the second position information based on a result of the determining of whether the first position information is generated in an abnormal state; and
controlling the autonomous driving vehicle based on a selection result of the selecting of the first position information or the second position information.

12. The method according to claim 11, wherein the generating of the first position information is performed by using at least one of a global positioning system (GPS), a virtual reference system (VRS), an inertial measurement unit (IMU), and an inertial navigation system (INS).

13. The method according to claim 11, further comprising:
generating motion control information of the autonomous driving vehicle, based on at least one of the first position information, digital map information, and driving environment recognition information,
wherein the determining comprises determining whether the motion control information is generated in an abnormal state.

14. The method according to claim 13, wherein the determining comprises determining whether the first position information is generated in an abnormal state based on time information included in the first position information, and wherein the determining comprises determining whether the motion control information is generated in an abnormal state based on index information included in the motion control information.

15. The method according to claim 11, further comprising sensing at least one of a yaw rate, a wheel speed, a longitudinal speed, and a longitudinal acceleration of the autonomous driving vehicle,
wherein the generating of the second position information comprises generating the second position information based on sensing information sensed in the sensing.

16. The method according to claim 11, wherein the selecting of either the first position information or the second position information comprises:
selecting the second position information when it is determined that the first position information is generated in an abnormal state in the determining; and
selecting the first position information when it is determined that the first position information is generated in a normal state in the determining;

17. The method according to claim 15, wherein the generating of the second position information comprises:
deriving current position information based on the first position information;
predicting information of at least one of a vehicle heading, a vehicle speed, and a road slope based on the sensing information sensed in the sensing; and
generating the second position information by applying at least a piece of the predicted information to the current position information.

18. The method according to claim 17, wherein the generating of the second position information further comprises:
initializing the second position information based on the first position information when a duration time in which the second position information is continuously generated is longer than a predetermined time or when an error of the second position information is greater than a predetermined allowable error.

19. The method according to claim 17, wherein the generating of the second position information further comprises:
updating the second position information by using the second position information as the current position information when a duration time in which the second position information is continuously generated is not longer than a predetermined time or when an error of the second position information is not greater than a predetermined allowable error.

20. The method according to claim 11, wherein the controlling of the autonomous driving vehicle comprises:
performing emergency braking of the autonomous driving vehicle when it is determined that the first position information is generated in an abnormal state in the determining.
